(19) United States
(12) Patent Application Publication
(10) Pub. No.: US 2022/0296459 A1
(43) Pub. Date: Sep. 22, 2022

(54) FLOWER-SHAPED MASSAGER HAVING TRANSPARENT HOUSING

(71) Applicant: Lianzhi(Huizhou) Gifts Manufacturing Co., Ltd, Guangdong (CN)

(72) Inventor: Feng Jin, Guangdong (CN)

(73) Assignee: Lianzhi(Huizhou) Gifts Manufacturing Co., Ltd, Guangdong (CN)

(21) Appl. No.: 17/481,318

(22) Filed: Sep. 22, 2021

(30) Foreign Application Priority Data
Mar. 16, 2021 (CN) 202120539515.4
Apr. 22, 2021 (CN) 202120831993.2

(51) Int. Cl. A61H 19/00; A61H 23/02

(52) U.S. Cl. CPC A61H 19/34; A61H 23/0254; A61H 2201/01; A61H 2201/1215

(57) ABSTRACT

A flower-shaped massager having a transparent housing includes an upper housing, a lower housing, a main frame and a silicone cover. The main frame is connected to the upper housing and the lower housing. The silicone cover is sleeved on an outside of the upper housing and an outside of the lower housing. An upper end of the silicone cover has a silicone suction opening arranged on the main frame and set inside the upper housing. The main frame is provided with a drive motor, a transmission component, an eccentric wheel, a simulated tongue and a battery. The drive motor and transmission component are connected to the main frame. One end of the drive motor has a motor output shaft. The eccentric wheel is connected to the transmission component and connected to the motor output shaft. The transmission component is connected to the silicone suction and the simulated tongue respectively.

### CROSS-REFERENCE TO RELATED APPLICATION

This application claims the priority benefit of China application serial no. 202120539515.4, filed on Mar. 16, 2021 and China application serial no. 202120831993.2, filed on Apr. 22, 2021. The entirety of each of the above-mentioned patent applications is hereby incorporated by reference herein and made a part of this specification.

### BACKGROUND

### Field of the Disclosure

The disclosure relates to the technical field of sexual wellness products, in particular to a flower-shaped massager having a transparent housing.

### Description of Related Art

Nowadays many women are occupied with their jobs or busy with other aspects of their lives. Although their material lives have been improved significantly, they feel a great sense of loss in relationships, and they might not feel satisfactory in sexual wellness.

If massage equipment is used appropriately by a female to effectively massage her body, the massage equipment can facilitate the contraction and relaxation of the muscles at the bottom of her pelvis, strengthen the muscles at the bottom of her pelvis, and improve the ability to control her bladder. In this way, it is possible to help women to deal with the issue of feeling frigid as well as improve their mental health. Additionally, such massage equipment can also help the body prepare before pregnancy and recover after childbirth.

Current typical massagers for adults only have the functions of rotation and vibration, and cannot simulate the action of tongue licking, which results in low user experience.

### SUMMARY OF THE DISCLOSURE

The purpose of the disclosure is to provide a flower-shaped massager having a transparent housing. The massager has the functions of sucking and tongue licking, and greatly enhances the user experience, so as to solve the problems raised in the background art.

In order to achieve the above purpose, the disclosure provides the following technical solutions.

A flower-shaped massager having a transparent housing is provided, and the massager includes an upper housing, a lower housing, a main frame and a silicone cover. The upper housing is connected to the lower housing. The main frame is disposed in the upper housing and the lower housing. The main frame is connected to the upper housing and the lower housing respectively. The silicone cover is sleeved on an outside of the upper housing and an outside of the lower housing. An upper end of the silicone cover is provided with a silicone suction opening. The silicone suction opening is arranged on the main frame and set inside the upper housing. The main frame is provided with a drive motor, a transmission component, an eccentric wheel, a simulated tongue, and a battery. The drive motor and transmission component are all connected to the main frame. One end of the drive motor is provided with a motor output shaft. The eccentric wheel is connected to the transmission component and connected to the motor output shaft. The transmission component is connected to the silicone suction opening and the simulated tongue respectively. A magnetic charging device is arranged on the lower housing, and the magnetic charging device is electrically connected to the battery.

In another aspect of the disclosure, the transmission component includes a transmission rod and a connector. The transmission rod is fixedly connected to the connector, and an end portion of the transmission rod is arranged on the main frame. A middle portion of the connector is provided with a connecting groove, and a sleeve is fixed in the connecting groove.

In another aspect of the disclosure, the eccentric wheel is provided with an eccentric shaft and a bore. The eccentric shaft is inserted into the sleeve, and the motor output shaft is inserted into the bore.

In another aspect of the disclosure, a positioning base is fixedly arranged on the lateral side of the main frame, a round hole is provided on the positioning base, and the transmission rod passes through the round hole.

In another aspect of the disclosure, a first handle is provided at a bottom portion of the silicone suction opening. A second handle is provided at a top portion of the simulated tongue. The connector is connected to the first handle and the second handle respectively.

In another aspect of the disclosure, a circuit board and a switch button are connected to the main frame. The switch button, the drive motor and the battery are all electrically connected to the circuit board. One end of the switch button is arranged on the lateral side of the silicone cover.

In another aspect of the disclosure, a transparent protective cover is provided at a bottom portion of the lower housing, and the transparent protective cover is engaged with the lower housing.

In another aspect of the disclosure, a transparent housing is provided on an outside of the silicone cover. The silicone cover is arranged in the transparent housing. A base is provided at a bottom portion of the transparent housing. The transparent housing is engaged with the base. A middle portion of the base is provided with a slot, and one end of the transparent protective cover is inserted into the slot.

Compared with the conventional technologies, the advantageous effects of the disclosure are as follows.

The massager of the disclosure has a simple structure with reasonable design. Only a drive motor is required for driving, such that the massager can realize the functions of sucking and tongue licking simultaneously, thus the user experience is greatly enhanced. By arranging a transparent housing on the outside of the silicone cover, and arranging a base at the bottom of the transparent housing, the silicone cover can be effectively protected.

### BRIEF DESCRIPTION OF THE DRAWINGS

FIG. 1 is a side view of a massager of the disclosure.

FIG. 2 is a three-dimensional view of the massager of the disclosure.

FIG. 3 is a schematic structural view of the massager of the disclosure with a transparent housing and a base being removed.

FIG. 4 is a schematic structural view of the massager of the disclosure with the transparent housing, the base, and a silicone cover being removed.

FIG. 5 is an exploded view of the massager of the disclosure.

FIG. 6 is an assembly view of a motor, a transmission component, and an eccentric wheel in the massager of the disclosure.

### DESCRIPTION OF EMBODIMENTS

The following will clearly and thoroughly describe the technical solutions in the embodiments of the disclosure with reference to the accompanying drawings in the embodiments of the disclosure. Obviously, the described embodiments are only a part of the embodiments of the disclosure, not all the embodiments of the disclosure. Based on the embodiments of the disclosure, all other embodiments obtained by those of ordinary skill in the art without creative work shall fall within the scope to be protected by the disclosure.

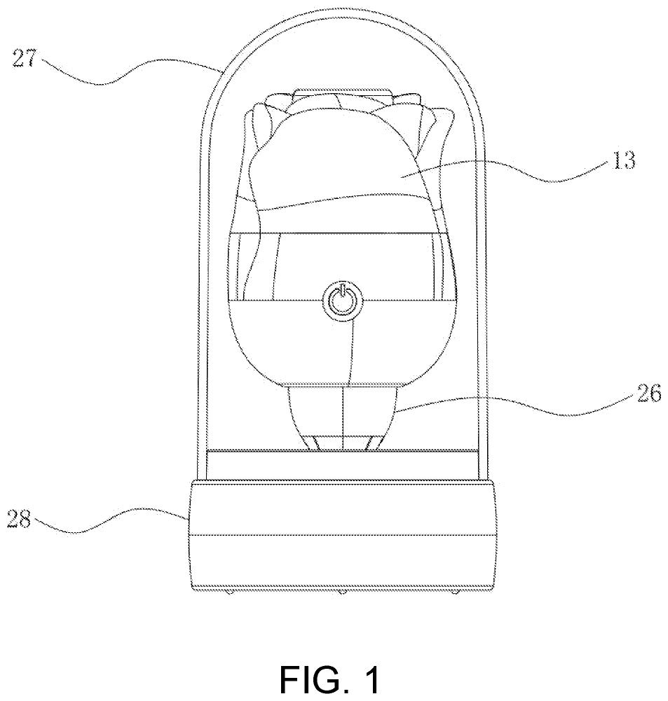

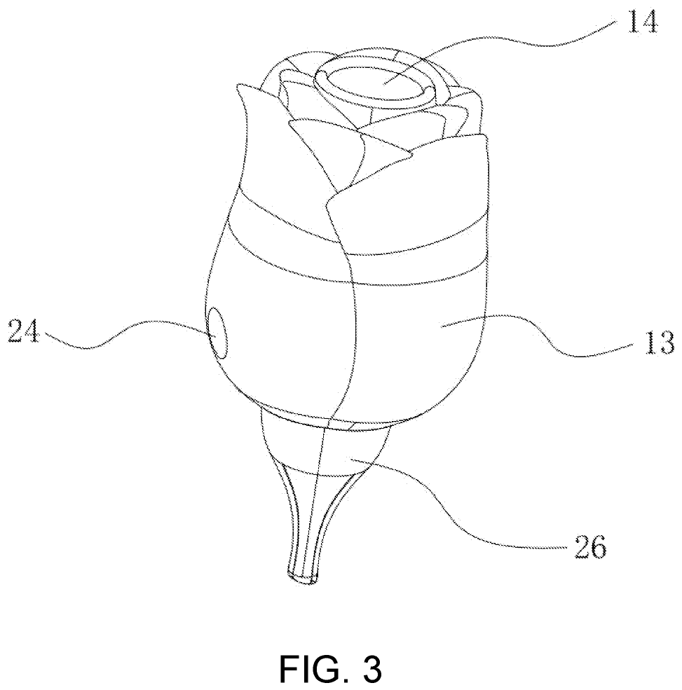

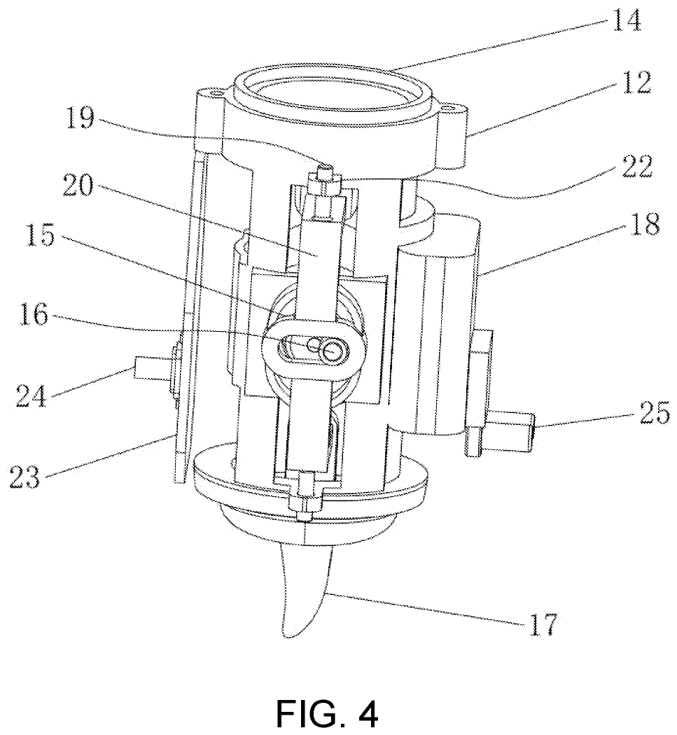

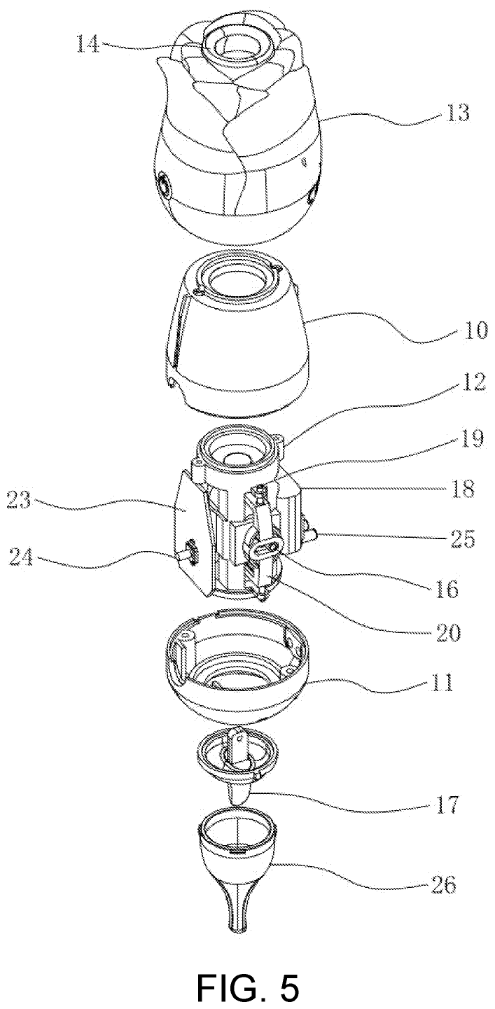

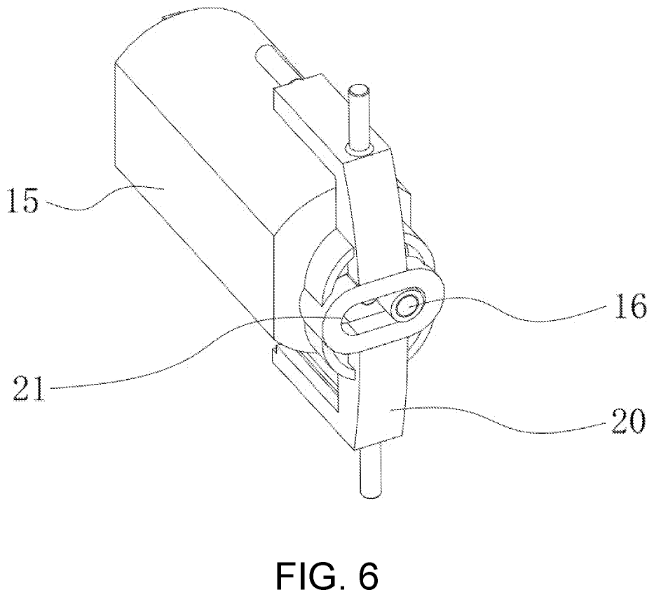

Please refer to the FIG. 1 to FIG. 6. In the embodiment of the disclosure, a flower-shaped massager having a transparent housing includes an upper housing 10, a lower housing 11, a main frame 12 and a silicone cover 13. The upper housing 10 is engaged with the lower housing 11. The main frame 12 is arranged in the upper housing 10 and the lower housing 11. The main frame 12 is fixedly connected to the upper housing 10 and the lower housing 11, respectively. The silicone cover 13 is sleeved on an outside of the upper housing 10 and an outside of the lower housing 11. An upper end of the silicone cover 13 is provided with a silicone suction opening 14. The silicone suction opening 14 is fixedly arranged on the main frame 12 and arranged inside the upper housing 10. The silicone cover 13 of the massager of the disclosure is in the shape of a flower, and the inside of the massager is a flower-shaped vibrating sex toy. The main frame 12 is provided with a drive motor 15, a transmission component, an eccentric wheel 16, a simulated tongue 17 and a battery 18. The drive motor 15 and the transmission component are all fixedly connected to the main frame 12. One end of the drive motor 15 is provided with a motor output shaft. The eccentric wheel 16 is fixedly connected to the transmission component and is fixedly connected to the motor output shaft. The transmission component is fixedly connected to the silicone suction opening 14 and the simulated tongue 17 respectively. Further, the transmission component includes a transmission rod 19 and a connector 20. The transmission rod 19 is fixedly connected to the connector 20, and an end portion of the transmission rod 19 is arranged on the main frame 12. A middle portion of the connector 20 is provided with a connecting groove 21, and a sleeve is fixed in the connecting groove 21. Further, an eccentric shaft and a bore are provided on the eccentric wheel 16. The eccentric shaft is fixed on the eccentric wheel 16. The eccentric shaft is inserted into the sleeve. The motor output shaft is inserted into the bore. When the drive motor 15 rotates, the eccentric shaft rotates synchronously, driving the transmission rod 19 and the connector 20 to reciprocate up and down. Then the connector 20 drives the silicone suction opening 14 and the simulated tongue 17 to reciprocate up and down, so as to realize the functions of sucking and tongue licking simultaneously. Moreover, in a preferred embodiment of the disclosure, a magnetic charging device 25 is provided on the lower housing 11, and the magnetic charging device 25 is electrically connected to the battery 18. The magnetic charging device 25 realizes the function of charging the lithium battery 18. The massager of the disclosure has a simple structure with reasonable design. Only the drive motor 15 is required for driving, such that the massager can realize the functions of sucking and tongue licking simultaneously, and that the user experience is greatly enhanced.

In a preferred embodiment of the disclosure, a positioning base 22 is fixedly provided on the lateral side of the main frame 12, and a round hole is provided on the positioning base 22. The transmission rod 19 passes through the round hole and can move up and down in the round hole. Moreover, the main frame 12 is connected to a circuit board 23 and a switch button 24. The switch button 24, the drive motor 15 and the battery 18 are all electrically connected to the circuit board 23. One end of the switch button 24 is disposed on the lateral side of the silicone cover 13, and the switch button 24 can activate the turn-on function and turn-off function.

In a preferred embodiment of the disclosure, a first handle is provided at a bottom portion of the silicone suction opening 14, and a second handle is provided at a top portion of the simulated tongue 17. The connector 20 is connected to the first handle and the second handle respectively. When the transmission rod 19 and the connector 20 perform high-speed reciprocating movement, the connector 20 drives the silicone suction opening 14 and the simulated tongue 17 to reciprocate, thereby achieving the functions of sucking and tongue licking simultaneously.

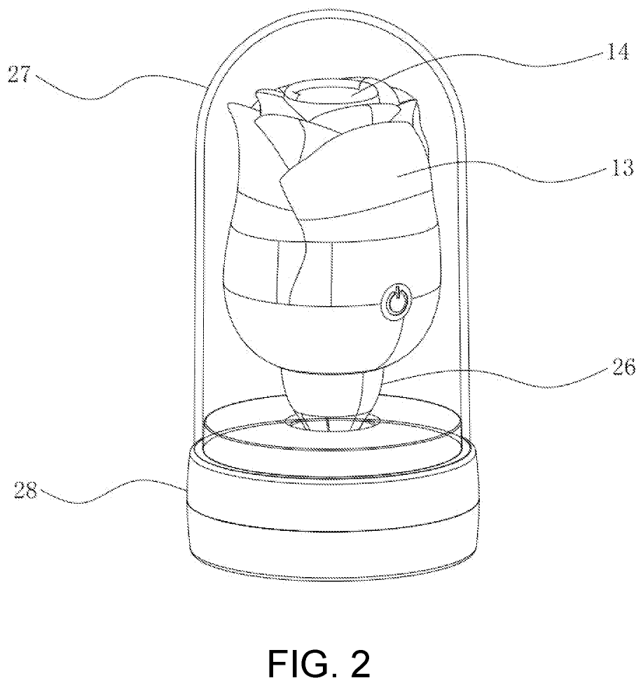

In a preferred embodiment of the disclosure, please refer to FIG. 1 and FIG. 2. The silicone cover 13 is provided with a transparent housing 27 on the outside. The silicone cover 13 is provided in the transparent housing 27. A bottom portion of the transparent housing 27 is provided with a base 28. The transparent housing 27 is engaged with the base 28. A middle portion of the base 28 is provided with a slot. One end of the transparent protective cover 26 is inserted into the slot. By providing a transparent housing 27 on the outside of the silicone cover 13 and arranging a base 28 at the bottom portion of the transparent housing 27, the silicone cover 13 can be effectively protected. According to actual needs, the massager of the disclosure may not require the transparent housing 27 and the base 28. Furthermore, a transparent protective cover 26 is provided at a bottom portion of the lower housing 11, and the transparent protective cover 26 is engaged with the lower housing 11, and the transparent protective cover 26 protects the simulated tongue 17.

The operation principle of the disclosure is as follows. When the massager of the disclosure is in operation, after the battery 18 is charged by the magnetic charging device 25, the drive motor 15 can be started by the switch button 24, and the motor output shaft of the drive motor 15 can rotate and drive the eccentric wheel 16 to move. The eccentric wheel 16 converts the rotational movement into a linear reciprocating movement, and drives the transmission rod 19 and the connector 20 to perform high-speed reciprocating movement, and then the connector 20 drives the silicone suction opening 14 and the simulated tongue 17 to reciprocate, thereby generating airflow that circulates up and down and realizing the sucking function. In the meantime, the connector 20 drives the simulated tongue 17 to vibrate at a high speed to simulate the tongue-licking function.

The massager of the disclosure has a simple structure with reasonable design. Only a drive motor 15 is required for driving, such that the massager can realize the functions of sucking and tongue licking simultaneously, and thus the user experience is greatly enhanced. By arranging a transparent housing 27 on the outside of the silicone cover 13, and arranging a base 28 at the bottom portion of the transparent housing 27, the silicone cover 13 can be effectively protected.

Although the disclosure has been described in detail with reference to the foregoing embodiments, those skilled in the art can still modify the technical solutions described in the foregoing embodiments, or make equivalent replacements to some of the technical features. Within the spirit and principle of the disclosure, any modification, equivalent replacement, improvement, etc., shall be included in the scope to be protected by the disclosure.

What is claimed is:

1. A flower-shaped massager having a transparent housing, the massager comprising an upper housing, a lower housing, a main frame and a silicone cover,
wherein the upper housing is connected to the lower housing, the main frame is disposed in the upper housing and the lower housing, the main frame is connected to the upper housing and the lower housing respectively, the silicone cover is sleeved on an outside of the upper housing and an outside of the lower housing, an upper end of the silicone cover is provided with a silicone suction opening, the silicone suction opening is arranged on the main frame and set inside the upper housing, the main frame is provided with a drive motor, a transmission component, an eccentric wheel, a simulated tongue, and a battery, the drive motor and transmission component are all connected to the main frame, one end of the drive motor is provided with a motor output shaft, the eccentric wheel is connected to the transmission component and connected to the motor output shaft, the transmission component is connected to the silicone suction opening and the simulated tongue respectively, a magnetic charging device is arranged on the lower housing, and the magnetic charging device is electrically connected to the battery.

2. The flower-shaped massager having the transparent housing according to claim 1, wherein the transmission component comprises a transmission rod and a connector, the transmission rod is fixedly connected to the connector, and an end portion of the transmission rod is arranged on the main frame, a middle portion of the connector is provided with a connecting groove, and a sleeve is fixed in the connecting groove.

3. The flower-shaped massager having the transparent housing according to claim 2, wherein the eccentric wheel is provided with an eccentric shaft and a bore, the eccentric shaft is inserted into the sleeve, and the motor output shaft is inserted into the bore.

4. The flower-shaped massager having the transparent housing according to claim 2, wherein a positioning base is fixedly arranged on a lateral side of the main frame, a round hole is provided on the positioning base, and the transmission rod passes through the round hole.

5. The flower-shaped massager having the transparent housing according to claim 2, wherein a first handle is provided at a bottom portion of the silicone suction opening, a second handle is provided at a top portion of the simulated tongue, the connector is connected to the first handle and the second handle respectively.

6. The flower-shaped massager having the transparent housing according to claim 1, wherein a circuit board and a switch button are connected to the main frame, the switch button, the drive motor and the battery are all electrically connected to the circuit board, and one end of the switch button is arranged on a lateral side of the silicone cover.

7. The flower-shaped massager having the transparent housing according to claim 1, wherein a transparent protective cover is provided at a bottom portion of the lower housing, and the transparent protective cover is engaged with the lower housing.

8. The flower-shaped massager having the transparent housing according to claim 7, wherein the transparent housing is provided on an outside of the silicone cover, the silicone cover is arranged in the transparent housing, a base is provided at a bottom portion of the transparent housing, the transparent housing is engaged with the base, a middle portion of the base is provided with a slot, and one end of the transparent protective cover is inserted into the slot.
